(19) United States
(12) Patent Application Publication
(10) Pub. No.: US 2014/0298660 A1
(43) Pub. Date: Oct. 9, 2014

(54) AIR-POWERED HAIR CUTTER

(71) Applicant: HAIM SHELEMEY, LONDON (GB)

(72) Inventor: HAIM SHELEMEY, LONDON (GB)

(21) Appl. No.: 14/299,555

(22) Filed: Jun. 9, 2014

(51) Int. Cl. B26B 19/20

(52) U.S. Cl. CPC B26B 19/205
USPC 30/133

(57) ABSTRACT

A hair cutting device 1 comprises a turbine 15 seated with and rotatable relative to a housing 10. The turbine 15 and the housing 10 each have one part of a co-operating rotary shear blade 25, 55 fixedly attached to them such that rotation of the turbine 15 relative to the housing 10 creates a shearing cutting action. Rotation of the turbine 15 is achieved by pulling air over the turbine 15 with a vacuum generating device, such as household vacuum cleaner.

### BACKGROUND OF THE INVENTION

The present invention relates to a cutting device for cutting hair powered by air flow.

### BRIEF SUMMARY OF THE INVENTION

In a first aspect, the present invention provides a hair cutting device comprising: a housing having a first part of a co-operating shear blade fixedly attached thereto; a second part of a co-operating shear blade in operative contact with the first part of the co-operating shear blade; a length adjustor screwably attachable to the housing and screwable to adjust a distance between the co-operating shear blades and a front surface of the length adjustor; and a turbine seated within the housing rotatably movable relative to the housing; wherein a flow of air through the device causes the turbine to rotate within the housing, the rotation causing relative motion of the first and second parts of the co-operating shear blades and creating a shearing cutting action between them.

Advantageously, embodiments of the present invention provide a hair cutting device which sucks hair towards the cutting blades, assisting in more even cutting, and the air flow also removes cut hair from the area. The desired length of hair can be easily selected by adjusting the screwable length adjustor.

Preferably, the second part of the co-operating shear blade is fixedly attached to the turbine such that rotation of the turbine causes a rotation of the second part of the co-operating shear blade. This ensures a simple rotary action between the cutting blades. Alternatively, rotation of the turbine causes an oscillating movement of the second part of the co-operating shear blade.

Preferably, the device is adapted for attachment to a vacuum cleaner. This ensures that the device can be made cheaply since it does not require its own power supply. Also, waste hair is automatically sucked into the vacuum cleaner for easy disposal. Alternatively, the device incorporates a vacuum generator to produce a useful standalone device.

### BRIEF DESCRIPTION OF THE SEVERAL VIEWS OF THE DRAWINGS

A preferred embodiment of the present invention will now be described by way of an example only and with reference to the accompanying drawings in which:

FIG. 1 is an exploded perspective view of the main components of a cutting device embodying the present invention;

FIG. 2 is a exploded side view of the cutting device;

FIG. 3 is a perspective view of the assembled cutting device when assembled; and

FIG. 4 is a side view of the assembled cutting device.

### DETAILED DESCRIPTION OF THE INVENTION

The Figures show a hair cutting device 1 adapted to be attached to a vacuum generator, such as a household vacuum cleaner. The device can be used to cut human hair or animal (e.g. household pets) hair.

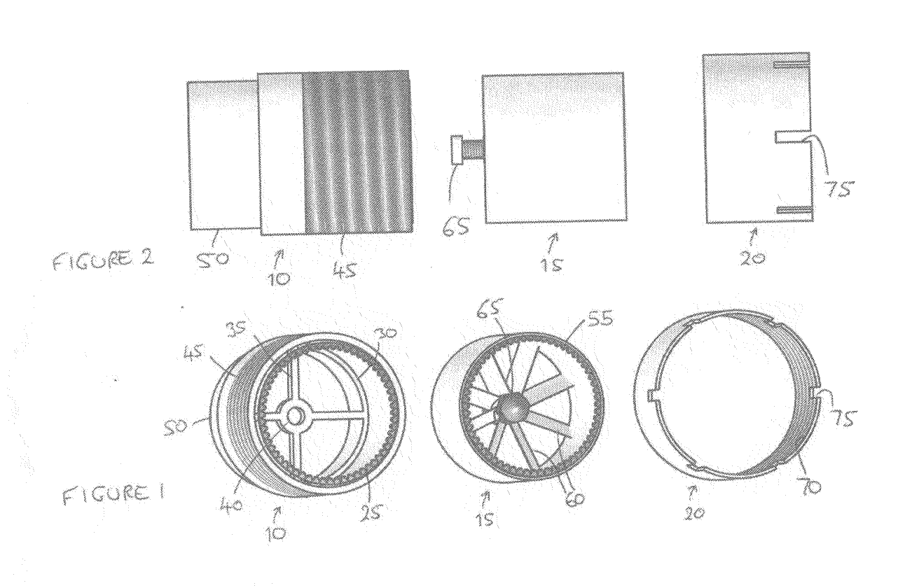

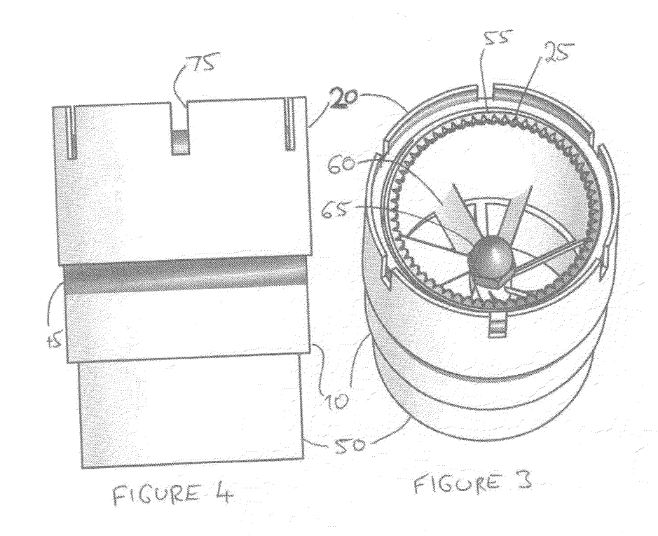

The cutting device 1 comprises three main components illustrated in the exploded views of FIGS. 1 and 2: a tubular housing 10, a turbine 15 and a length adjustor 20. When assembled, as illustrated in FIGS. 3 and 4, the turbine 15 sits within and is rotatably connected to the housing 10 and the length adjustor 20 is movably screwed to the housing 10.

The tubular housing 10 includes a first part of a co-operating toothed rotary blade 25 fixedly located flush with or attached to a front surface of the entrance to the housing 10. The interior of the housing 10 includes a ledge or lip 35 from which crossbars or other support struts 35 lead to a central connection point 40. An outer surface of the housing 10 is provided with a screw thread 45 leading from the front surface of the entrance to the housing 10 down a portion of its length. A rear connector portion 50 of the housing 10 is sized to or adaptable to be received by a househould vacuum cleaner.

The turbine 15 includes a second part of a co-operating toothed rotary blade 55 fixedly located flush with or attached to a front surface of the entrance to the turbine 15. The interior of the turbine 15 is provided with a plurality of aerofoils 60 radiating from a central point to form an axial turbine. The central point is provide with bolt 65 extending out of the rear end of the turbine 15.

The length adjustor 20 is provided with a screw thread on its interior surface 70. A front surface of the length adjustor 20 is provided with a plurality of notches 75 for permitting the flow of air.

To assemble the cutting device 1, the turbine 15 is located within the front portion of the tubular housing 10, seated against the ledge 30, with the bolt 65 passing through the central connection point 40. The exterior radius of the turbine 15 is slightly smaller than the interior radius of the housing 10 so that the turbine 15 is free to rotate within the housing 10. When the turbine 15 is seated within the housing 10, the first and second parts of the co-operating rotary blades 25, 55 are in operable contact with one another such that rotation of the turbine 15 relative to the housing 10 produces a shearing cutting action between the teeth of the blades. The length adjustor 20 is screwed onto the housing 10 by way of the co-operating screw threads 45, 70 and rotation of the length adjustor 20 about the screw adjustably changes the distance between the front surface of the length adjustor 20 and the blades 25, 55.

In use, the cutting device 1 is attached to a vacuum-generating device such as a vacuum cleaner via the rear connection portion 50. Operation of the vacuum cleaner produces a flow of air into the front of the device 1 which passes over the aerofoils 60 of the turbine 15. This flow of air causes the turbine 15 to rotate within the housing 10 creating a shearing cutting force between the first part of the co-operative rotary blade 25 fixedly attached to the housing 10 and the second part of the co-operative rotary blade 55 fixedly attached to the turbine 15.

The position of the length adjustor 20 on the housing 10 is changed by screwing it to a desired position to give a desired hair length. The front of the device 1 is then brought into contact with the person or animal to be shaved. Air is still able to flow through the notches 75 in the length adjustor 20, preventing the formation of a vacuum seal, and hair caught between the rotary blades 25,55 is shorn off and sucked through the device 1 into the vacuum cleaner.

Although a preferred embodiment of the invention has been described above, the skilled person will recognise that various alterations may be made without departing from the scope of the invention. For example, although the cutting device has been described as being attachable to a vacuum generating device, the cutting device may incorporate its own vacuum generator and be manufactured as a single standalone device.

Another variation is to produce an oscillating cutting motion instead of a rotary cutting motion. This variation is achieved by splitting the turbine 20 into two separate components: a turbine component and a blade component. The blade component carries the second part of the co-operative blade and is rotatable relative to the housing 10 but is spring-loaded, forcing it to return to a start position. The turbine component is also rotatable relative to the housing, as with the turbine 15 in the main embodiment described above, and rotates when a flow of air passes through the device. The turbine component is linked to the blade component such that it carries the blade component round with it for a portion of its motion then releases the blade component, which springs back towards its start position due to the spring-loading. As the turbine component continues to rotate, the blade component is again picked up and carried by the turbine component for a portion of its motion. In this way, an oscillating shaving action is created.

1. A hair cutting device comprising:
a housing having a first part of a co-operating shear blade fixedly attached thereto;
a second part of a co-operating shear blade in operative contact with the first part of the co-operating shear blade;
a length adjustor screwably attachable to the housing and screwable to adjust a distance between the co-operating shear blade and a front surface of the length adjustor; and
a turbine seated within the housing rotatably movable relative to the housing;
wherein a flow of air through the device causes the turbine to rotate within the housing, the rotation causing relative motion of the first and second parts of the co-operating shear blades and creating a shearing cutting action between them.

2. The hair cutting device of claim 1 wherein the second part of the co-operating shear blade is fixedly attached to the turbine such that rotation of the turbine causes a rotation of the second part of the co-operating shear blade.

3. The hair cutting device of claim 1 wherein rotation of the turbine causes an oscillating movement of the second part of the co-operating shear blade.

4. The hair cutting device of claim 1 wherein the device is adapted for attachment to a vacuum cleaner.

5. The hair cutting device of claim 1 wherein the device incorporates a vacuum generator.
